(19) United States
(12) Patent Application Publication
(10) Pub. No.: US 2025/0377002 A1
(43) Pub. Date: Dec. 11, 2025

(54) VEHICLE INTERIOR PART ATTACHING STRUCTURE

(71) Applicant: KOJIMA INDUSTRIES CORPORATION, Toyota-shi (JP)

(72) Inventor: Soma HIGASHITANI, Toyota-shi (JP)

(73) Assignee: KOJIMA INDUSTRIES CORPORATION, Toyota-shi (JP)

(21) Appl. No.: 19/230,603

(22) Filed: Jun. 6, 2025

(30) Foreign Application Priority Data
Jun. 11, 2024 (JP) 2024-094219

(51) Int. Cl. F16B 5/06; B60R 7/04

(52) U.S. Cl. CPC F16B 5/06; B60R 7/04

(57) ABSTRACT

A vehicle interior part attaching structure for attaching a vehicle interior part to a vehicle component formed as a part of a vehicle body, wherein the vehicle component includes a pair of attachment portions formed therein and configured to be oriented perpendicular to the vehicle body, and wherein the vehicle interior part includes a vehicle interior part main body having side walls and a pair of side panels having inner surfaces, may be provided. Each of the attachment portions includes engagement holes formed therein. The vehicle interior part main body includes a pair of clamping members. Each of the side panels includes engagement strips formed on each of the inner surfaces. The vehicle interior part main body is connected to the attachment portions with the clamping members clamping the attachment portions. The side panels are connected to the side walls of the interior part main body with the engagement strips engaging the engagement holes of the attachment portions.

### CROSS-REFERENCE TO RELATED APPLICATIONS

This application claims priority to a Japanese Patent Application serial number 2024-094219 filed Jun. 11, 2024, the contents of which is hereby incorporated herein by reference in its entirety for all purposes.

### BACKGROUND

The disclosure relates to a vehicle interior part attaching structure for attaching a vehicle interior part (e.g., a console box) to a vehicle component formed as a part of a vehicle body (e.g., a vehicle panel).

Conventionally, a vehicle (e.g., an automobile) includes a interior part (e.g., a console box) attached thereto. Generally, the vehicle interior part is attached to a vehicle component secured to or formed as a part of a vehicle body (e.g., a vehicle panel) using bolts. Further, the vehicle interior part may be attached to the vehicle component by using clips instead of the bolts. Such a vehicle interior part attaching structure using the clips is taught, for example, by Japanese Laid-Open Patent Application No. 2005-306247 (JPA2005-306247). According to the attaching structure taught by JPA2005-306247, the vehicle interior part can be attached to the vehicle component by simply inserting the clips formed in the vehicle interior part into engagement holes formed in an attachment portion of the vehicle component. Therefore, the vehicle interior part can be easily and quickly attached to the vehicle component without using tools.

The attaching structure taught by JPA2005-306247 is suitable for attaching the vehicle interior part to the vehicle component in scenarios where the attachment portion of the vehicle component is oriented parallel to the vehicle body. However, the attaching structure is not suitable for attaching the vehicle interior part to the vehicle component in scenarios where the attachment portion of the vehicle component is substantially oriented vertical to the vehicle body. In addition, in the attaching structure, once the vehicle interior part is attached, it cannot be easily detached from the vehicle component because the clips are provided with retaining tabs.

### SUMMARY

In one aspect of the present disclosure, a vehicle interior part attaching structure for attaching a vehicle interior part to a vehicle component formed as a part of a vehicle body, wherein the vehicle component includes a pair of attachment portions formed therein and configured to be oriented perpendicular to the vehicle body, and wherein the vehicle interior part includes a vehicle interior part main body having side walls and a pair of side panels having inner surfaces, may be provided. In the vehicle interior part attaching structure, each of the attachment portions includes engagement holes formed therein. The vehicle interior part main body includes a pair of clamping members. Each of the side panels includes engagement strips formed on each of the inner surfaces. The vehicle interior part main body is connected to the attachment portions with the clamping members clamping the attachment portions. The side panels are connected to the side walls of the interior part main body with the engagement strips engaging the engagement holes of the attachment portions.

According to the structure, the vehicle interior part can be attached to the vehicle component when the attachment portions of the vehicle component are oriented perpendicular to the vehicle body. In addition, the vehicle interior part can be easily detached from the vehicle component as needed.

Other objects, features and advantages of the present invention will be readily understood after reading the following detailed description together with the accompanying drawings and the claims.

### BRIEF DESCRIPTION OF THE DRAWINGS

For a detailed description of various exemplary embodiments, reference will now be made to the accompanying drawings in which:

FIG. 1 is a perspective view of a console box according to a representative embodiment of the present disclosure, which illustrates a condition in which the console box is attached to right and left attachment brackets;

FIG. 2 is an exploded perspective view of the console box of FIG. 1, in which right and left side panels of the console box are partially omitted;

FIG. 3 is a bottom view of the console box of FIG. 2, in which the left side panel and the left bracket are omitted;

FIG. 4 is a bottom view of the console box main body of FIG. 1;

FIG. 5 is an enlarged view of the encircled section of the console box main body of FIG. 4;

FIG. 6 is a cross-sectional view of the console box and the right and left brackets of FIG. 1, which illustrates a condition in which the console box is disposed on the brackets in order to attach the console box to the right and left brackets;

FIG. 7 is a view similar to FIG. 6, in which the console box is pressed down toward the right and left brackets;

FIG. 8 is a view similar to FIG. 7, in which the console box is further pressed down toward the right and left brackets;

FIG. 9 is a view similar to FIG. 8, in which the console box is completely pressed down toward the right and left brackets;

FIG. 10 is a view similar to FIG. 9, in which a right side panel lower portion of the right side panel and a left side panel lower portion of the left side panel are slid forward relative to the right and left brackets in order to detach the console box from the right and left brackets; and

FIG. 11 is a view similar to FIG. 10, in which the right side panel lower portion of the right side panel and the left side panel lower portion of the left side panel are removed from a right side panel upper portion of the right side panel and a left side panel upper portion of the left side panel.

### DETAILED DESCRIPTION

As previously described, the attaching structure taught by JPA2005-306247 is not suitable for attaching the vehicle interior part to the vehicle component when the attachment portion of the vehicle component is oriented parallel to the vehicle body. In addition, in the attaching structure, the vehicle interior part once attached cannot be easily detached from the vehicle component. Therefore, there is a need in the art for an improved vehicle interior part attaching structure.

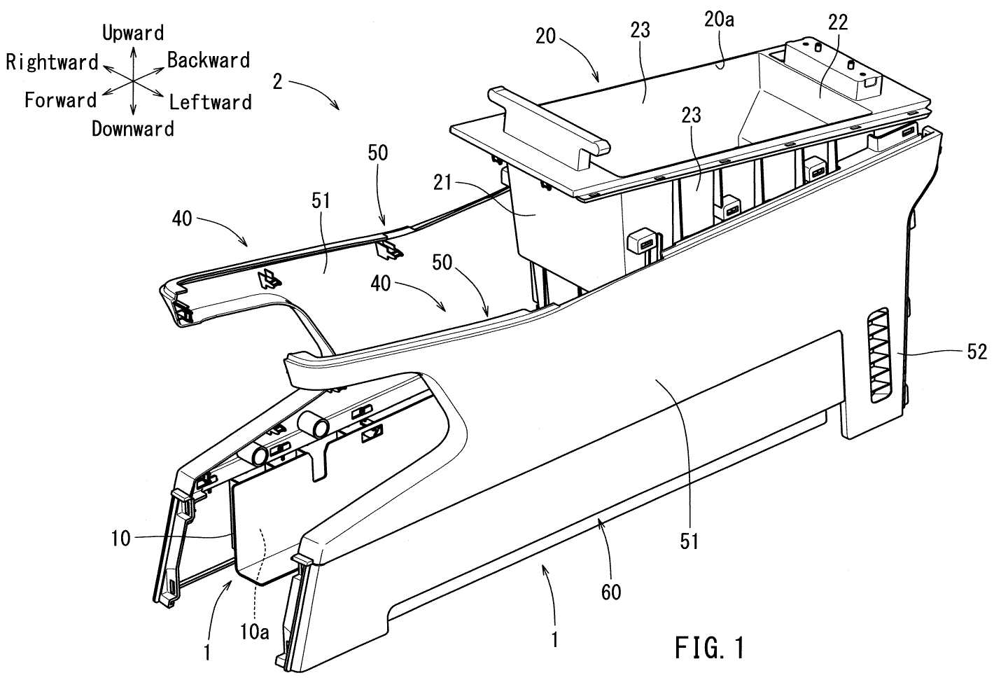

A representative embodiment will now be described in detail with reference to FIGS. 1 to 11. The embodiment is directed to a console box attaching structure for attaching a console box 2 (a vehicle interior part) to a pair of (right and left) attachment brackets 1 (a vehicle component) secured to a vehicle panel (a vehicle body) of a vehicle (not shown) such as an automobile. Further, forward, backward, rightward, leftward, upward, and downward directions described with reference to the figures may be defined as shown in the figure for descriptive purposes. Such directions may substantially correspond to forward, backward, rightward, leftward, upward, and downward directions of the vehicle.

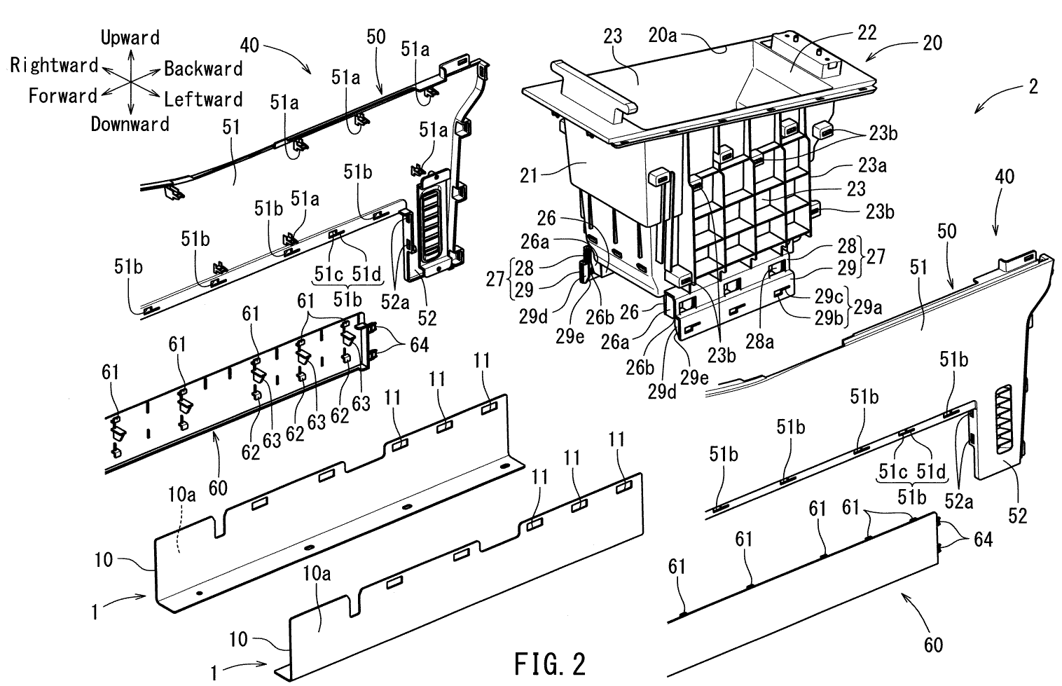

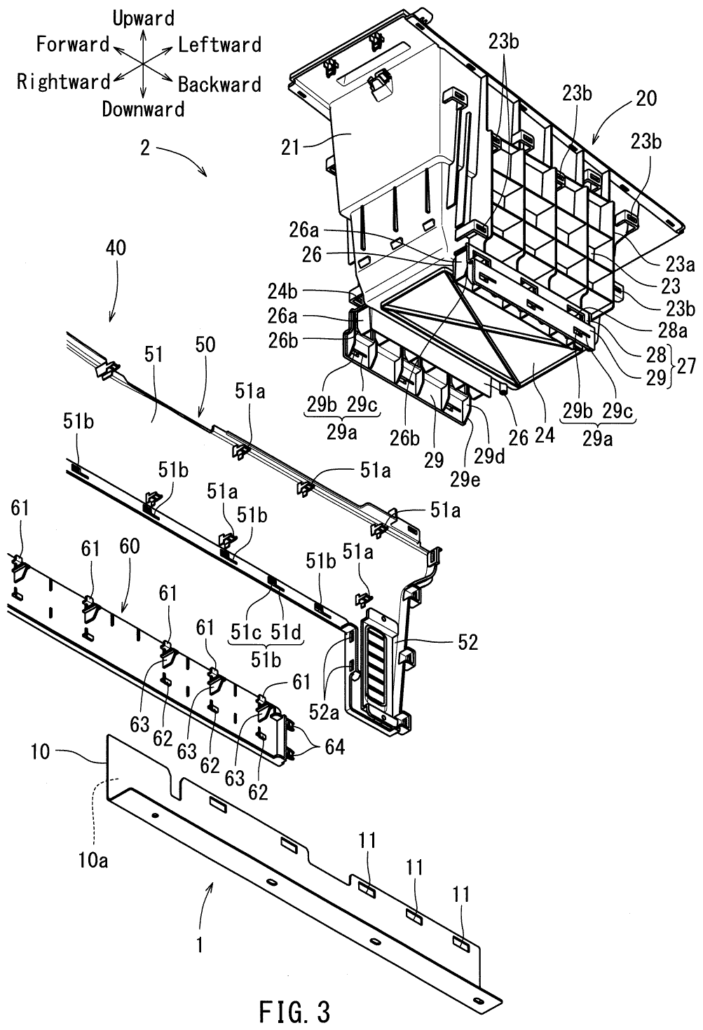

As shown in FIG. 1, the console box 2 is configured to be attached to the attachment brackets 1. As shown in FIGS. 2 and 3, the attachment brackets 1 are elongated rectangular plate-shaped metal panels formed in a symmetrical fashion. The attachment brackets 1 have an L-shape in cross section so as to have horizontal base portions (not labeled) and vertical attachment portions 10 extending perpendicularly from the base portions. The attachment portions 10 include attachment surfaces 10a. The attachment brackets 1 are arranged in parallel to each other in a front-back direction. The attachment brackets 1 are secured to the vehicle panel (not shown) via the base portions such that the attachment portions 10 (the attachment surfaces 10a) are oriented perpendicular to the vehicle panel.

As shown in FIGS. 2 and 3, each of the attachment portions 10 includes a plurality of (three in this embodiment) elongated engagement holes 11 formed along an upper edge thereof and spaced apart at intervals in the front-back direction. Each of the engagement holes 11 has a rectangular shape that is elongated in the front-back direction.

As shown in FIG. 2, the console box 2 includes a console box main body 20 and a pair of (right and left) side panels 40. The console box main body 20 is a laterally symmetrical box-shaped member having an upper opening 20a. As shown in FIGS. 2 and 3, the console box main body 20 includes a front wall 21, a rear wall 22, right and left side walls 23, and a bottom wall 24. The right and left side walls 23 are configured such that the side panels 40 are connected thereto.

As shown in FIGS. 2 and 3, the left side wall 23 of the console box main body 20 includes reinforcement members 23a formed on an outer surface thereof and arranged in a lattice-shaped pattern. Further, the left side wall 23 includes a plurality of (five in this embodiment) engagement holes 23b formed on the outer surface thereof.

As shown in FIGS. 2, 3, and 6, the left side wall 23 includes an elongate plate-shaped first downward projection 26 formed on a lower edge thereof and extending over the entire length thereof. The first downward projection 26 includes a plurality of (six in this embodiment) projecting strips 26a formed thereon and laterally projecting outward therefrom. Further, each of the projecting strips 26a includes a chamfered portion 26b formed in a lower corner thereof.

As shown in FIGS. 2, 3, and 6, the left side wall 23 includes an elongate plate-shaped second downward projection 27 formed on the lower edge thereof and extending over the entire length thereof. The second downward projection 27 is positioned laterally opposite to the first downward projection 26. Further, the second downward projection 27 includes a shouldered portion formed therein so as to have an upper projecting portion 28 and a lower projecting portion 29 separated by the shouldered portion. The upper projecting portion 28 includes a plurality of (three in this embodiment) elongated insertion holes 28a formed therein and spaced apart at predetermined intervals in the front-back direction. Each of the insertion holes 28a has a rectangular shape elongated in the front-back direction.

As shown in FIGS. 2, 3, and 6, the lower projecting portion 29 includes a plurality of (three in this embodiment) engagement holes 29a formed therein and spaced apart at predetermined intervals in the front-back direction. Each of the engagement holes 29a has a substantially L-shape elongated in the front-back direction. In particular, each of the engagement holes 29a includes a rectangular rear narrow portion 29c and a rectangular front wide portion 29b widened downward relative to the rear narrow portion 29c.

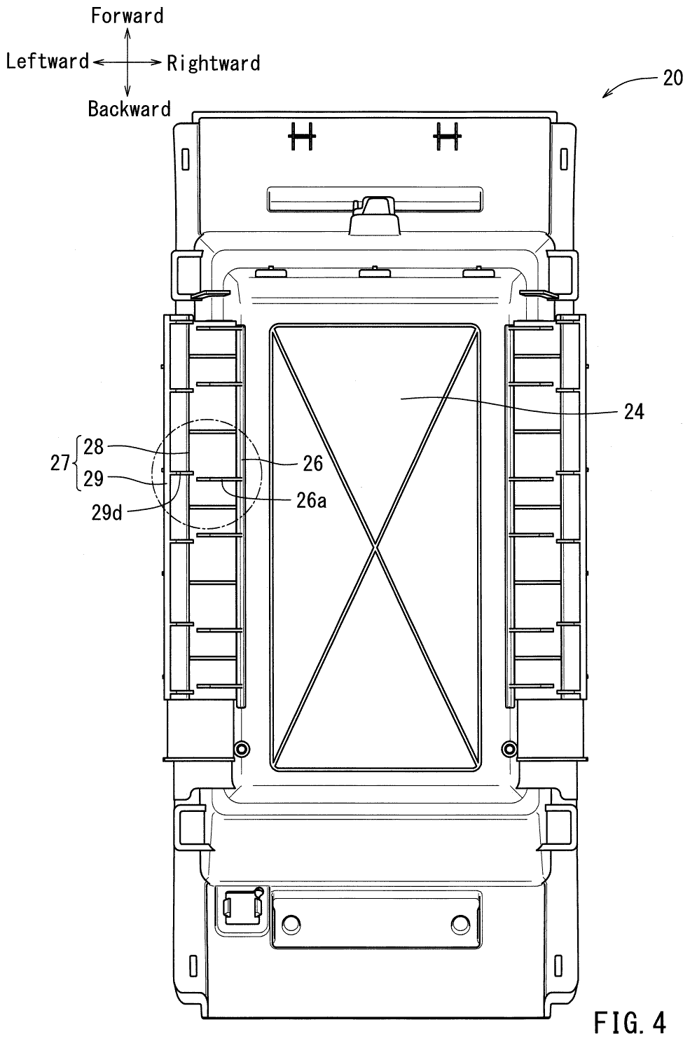

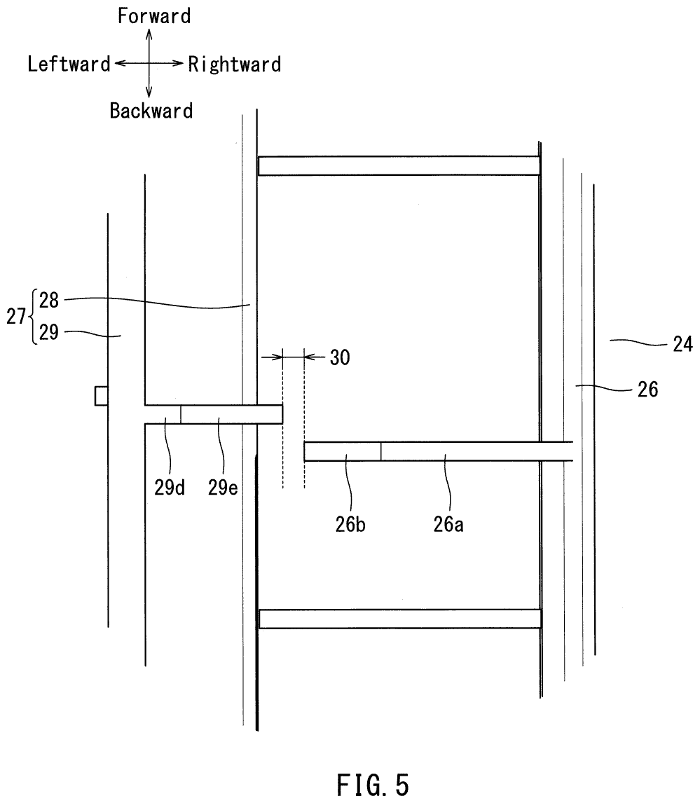

As shown in FIGS. 2, 3, and 6, the second downward projection 27 (the upper projecting portion 28 and the lower projecting portion 29) includes a plurality of (six in this embodiment) rectangular projecting strips 29d formed thereon and laterally projecting inward therefrom. Further, each of the projecting strips 29d includes a chamfered portion 29e formed in a lower corner thereof. As shown in FIGS. 4 and 5, the projecting strips 29d are configured to be positioned laterally opposite to the projecting strips 26a of the first downward projection 26 with a vertical gap or clearance 30 left therebetween. The clearance 30 is configured such that one of the attachment portions 10 of the attachment brackets 1 is introduced thereinto. In addition, the projecting strips 29d are configured to be slightly displaced (offset) from the projecting strips 26a of the first downward projection 26 in the front-back direction. The first downward projection 26 (the projecting strips 26a) and the second downward projection 27 (the projecting strips 29d) may also be referred to herein as “clamping members.”

Further, the vertical clearance 30 formed between the projecting strips 26a and the projecting strips 29d is equal to or slightly smaller than a thickness of one of the attachment portions 10 of the attachment brackets 1 such that the first downward projection 26 and the second downward projection 27 clamp one of the attachment portions 10 of the attachment brackets 1 that is introduced into the vertical clearance 30. In addition, the insertion holes 28a of the upper projecting portion 28 (the second downward projection 27) are configured to be laterally aligned with the engagement holes 11 of one of the attachment portions 10 when one of the attachment portions 10 is introduced into the vertical clearance 30.

Further, the right side wall 23 of the console box main body 20 has the same structure as the left side wall 23. Therefore, elements of the right side wall 23 are identified by the same reference numerals and a detailed description of such elements is omitted for purposes of simplicity and conciseness. Further, the console box main body 20 is integrally formed by integral molding of a hard synthetic resin.

The right and left side panels 40 have laterally symmetrical shapes. As shown in FIGS. 2, 3, and 6, the right side panel 40 includes a right upper (first) side panel element 50 and a right lower (second) side panel element 60 that are formed separately from each other. The right upper side panel element 50 includes a panel main portion 51 elongated in the front-back direction and a panel extension 52 extending downward from a rear end of the panel main portion 51. The panel main portion 51 includes a plurality of (five in this embodiment) engagement strips 51a formed on an inner surface thereof. The engagement strips 51a are arranged so as to correspond to the engagement holes 23b formed on the left side wall 23 of the console box main body 20. In addition, the panel main portion 51 includes a plurality of (five in this embodiment) engagement holes 51b formed along a lower edge thereof and arranged at predetermined intervals in the front-back direction.

As shown in FIGS. 2, 3, and 6, each of the engagement holes 51b has a substantially L-shape elongated in the front-back direction. In particular, each of the engagement holes 51b includes a rectangular rear narrow portion 51d and a rectangular front wide portion 51c widened in the upward direction relative to the rear narrow portion 51d.

As shown in FIGS. 2, 3, and 6, the panel extension 52 includes a plurality of (two in this embodiment) engagement holes 52a formed along a front edge thereof and spaced apart at predetermined intervals in a vertical direction.

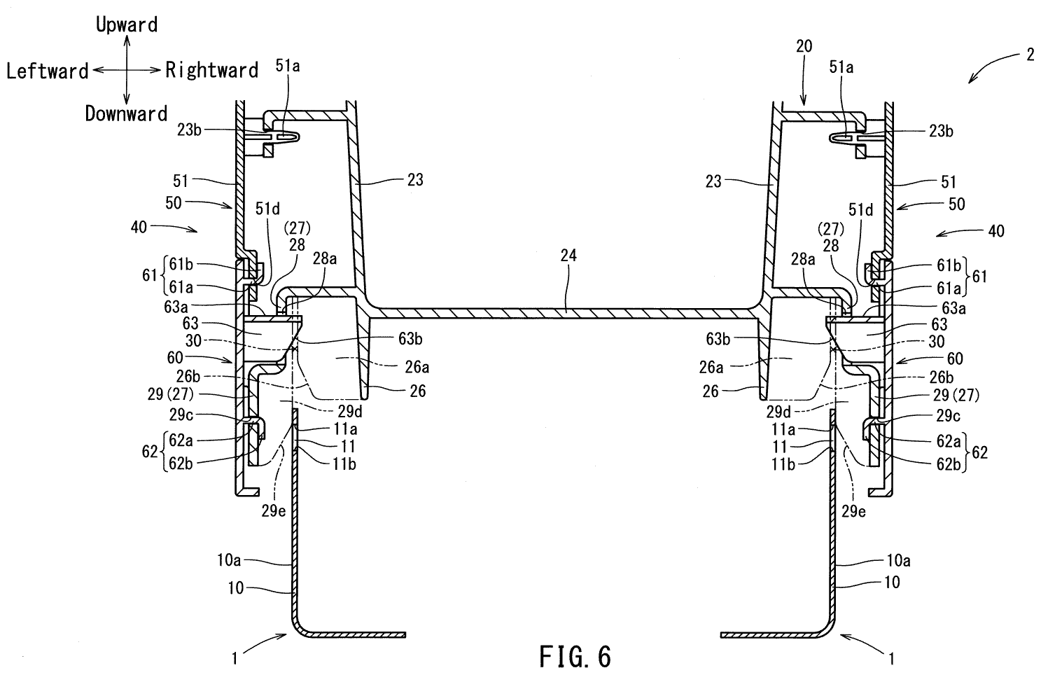

As shown in FIGS. 2, 3, and 6, the right lower side panel element 60 of the right side panel 40 includes a plurality of (five in this embodiment) hook-shaped upper engagement claws 61 formed on an inner surface thereof and spaced apart at predetermined intervals in the front-back direction along an upper edge thereof. Further, the upper engagement claws 61 are arranged so as to correspond to the engagement holes 51b formed on the panel main portion 51 of the right upper side panel element 50. Each of the upper engagement claws 61 has an L-shape in cross section. In particular, each of the upper engagement clows 61 has a horizontal base portion 61a and a vertical hook portion 61b bent upward with respect to the base portion 61a (FIG. 6).

As shown in FIGS. 2, 3, and 6, the right lower side panel element 60 includes three hook-shaped lower engagement claws 62 formed on the inner surface thereof and spaced apart at predetermined intervals in the front-back direction along a lower edge thereof. Further, the lower engagement claws 62 are arranged so as to correspond to the engagement holes 29a formed on the lower projecting portion 29 (the second downward projection 27) of the console box main body 20. Each of the lower engagement claws 62 has an L-shape in cross section. In particular, each of the lower engagement clows 62 has a horizontal base portion 62a and a vertical hook portion 62b bent downward with respect to the base portion 62a (FIG. 6).

As shown in FIGS. 2, 3, and 6, the right lower side panel element 60 includes a plurality of (three in this embodiment) engagement strips 63 formed on the inner surface thereof and arranged so as to be positioned above the lower engagement claws 62. Further, the engagement strips 63 are arranged so as to correspond to the insertion holes 28a formed on the upper projecting portion 28 (the second downward projection 27) of the console box main body 20. Each of the engagement strips 63 has a substantially T-shape in cross section. In addition, each of the engagement strips 63 has a flat horizontal upper surface 63a and an oblique end surface 63b sharply inclined with respect to the horizontal upper surface 63a (FIG. 6).

As shown in FIGS. 2 and 3, the right lower side panel element 60 includes a plurality of (two in this embodiment) engagement claws 64 formed along a rear edge thereof and spaced apart at predetermined intervals in the vertical direction. The engagement claws 64 are arranged so as to correspond to the engagement holes 52a formed on the panel extension 52 of the right upper side panel element 50.

Further, the left side panel 40 has the same structure as the right side panel 40. Therefore, elements of the left side panel 40 are identified by the same reference numerals and a detailed description of such elements is omitted for purposes of simplicity and conciseness. Further, in each of the right and left side panels 40, the right upper side panel element 50 and the right lower side panel element 60 are separately formed by integral molding of a hard synthetic resin.

Next, a method of assembling the console box 2 will now be described in detail with reference to FIGS. 2, 3, and 6 to 9.

First, the engagement stirps 51a formed on the left upper side panel element 50 (the panel main portion 51) of the left side panel 40 are inserted into the engagement holes 23b formed on the left side wall 23 of the console box main body 20, thereby attaching the left upper side panel element 50 to the console box main body 20.

Thereafter, the upper engagement claws 61 formed on the left lower side panel element 60 of the left side panel 40 are inserted into the front wide portions 51c of the engagement holes 51b formed in the left upper side panel element 50 of the left side panel 40. At the same time, the lower engagement claws 62 formed on the left lower side panel element 60 are inserted into the front wide portions 29b of the engagement holes 29a formed in the lower projecting portion 29 (the second downward projection 27) of the left side wall 23 of the console box main body 20. Upon insertion of the upper engagement claws 61 and the lower engagement claws 62, the engagement strips 63 formed on the left lower side panel element 60 laterally project into the vertical clearance 30 formed between the first downward projection 26 and the second downward projection 27 of the left side wall 23 through the insertion holes 28a formed on the upper projecting portion 28 (the second downward projection 27).

Thereafter, in this condition, the left lower side panel element 60 is slid backward relative to the left upper side panel element 50. Upon backward sliding of the left lower side panel element 60, the base portions 61a of the upper engagement claws 61 engage the rear narrow portions 51d of the engagement holes 51b. At the same time, the base portions 62a of the lower engagement claws 62 engage the rear narrow portions 29c of the engagement holes 29a. The engagement strips 63 freely move or slide within the insertion holes 28a without interfering with the second downward projection 27 (the console box main body 20). In addition, the engagement claws 64 formed on the left lower side panel element 60 engage the engagement holes 52a formed on the panel extension 52 of the left upper side panel element 50. As a result, the left lower side panel element 60 is removably coupled to the left upper side panel element 50, thereby forming the left side panel 40. Thus, the left side panel 40 is connected to the left side wall 23 of the console box main body 20 simultaneously with formation thereof (FIG. 6).

As shown in FIG. 6, when the base portions 61a of the upper engagement claws 61 engage the rear narrow portions 51d of the engagement holes 51b, the hook portions 61b of the upper engagement claws 61 are hooked on the left upper side panel element 50. Similarly, when the base portions 62a of the lower engagement claws 62 engage the rear narrow portions 29c of the engagement holes 29a, the hook portions 62b of the lower engagement claws 62 are hooked on the second downward projection 27 (the lower projecting portion 29) of the left side wall 23. Therefore, the left lower side panel element 60 is reliably prevented from being laterally separated from the left upper side panel element 50. In addition, the left lower side panel element 60 (the left side panel 40) is reliably prevented from being laterally separated from the left side wall 23 of the console box main body 20.

Further, the right side panel 40 is formed in the same manner as the left side panel 40. In addition, similar to the left side panel 40, the right side panel 40 is connected to the right side wall 23 of the console box main body 20 simultaneously with formation thereof. Thus, the assembly of the console box 2 is completed. Generally, the console box 2 thus assembled is distributed to users in this condition.

Next, a method of attaching the console box 2 to the right and left attachment brackets 1 and a method of detaching the console box 2 from the right and left attachment brackets 1 will now be described in detail with reference to FIGS. 6 to 9 and FIGS. 9 to 11.

First, in order to attach the console box 2 to the right and left attachment brackets 1, the console box 2 (the console box main body 20) is positioned above the right and left attachment brackets 1 with the vertical clearance 30 formed between the first downward projection 26 and the second downward projection 27 of each of the right and left side walls 23 of the console box main body 20 vertically aligned with each of the attachment portions 10 of the attachment brackets 1 (FIG. 6). In this condition, the console box 2 is pressed down toward the attachment brackets 1 (the attachment portions 10) such that each of the attachment portions 10 is introduced into the vertical clearance 30.

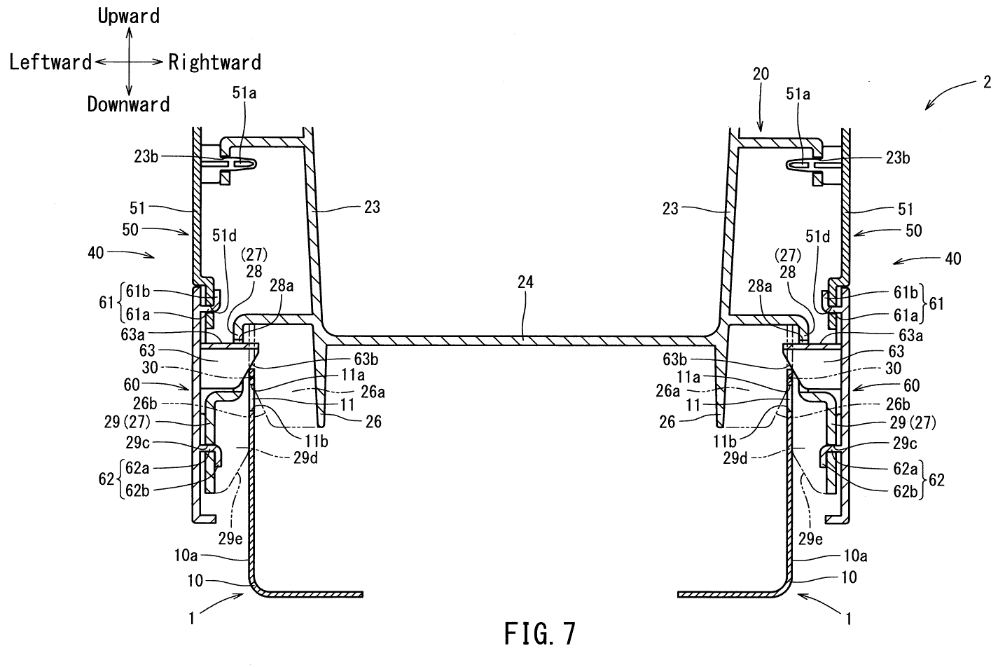

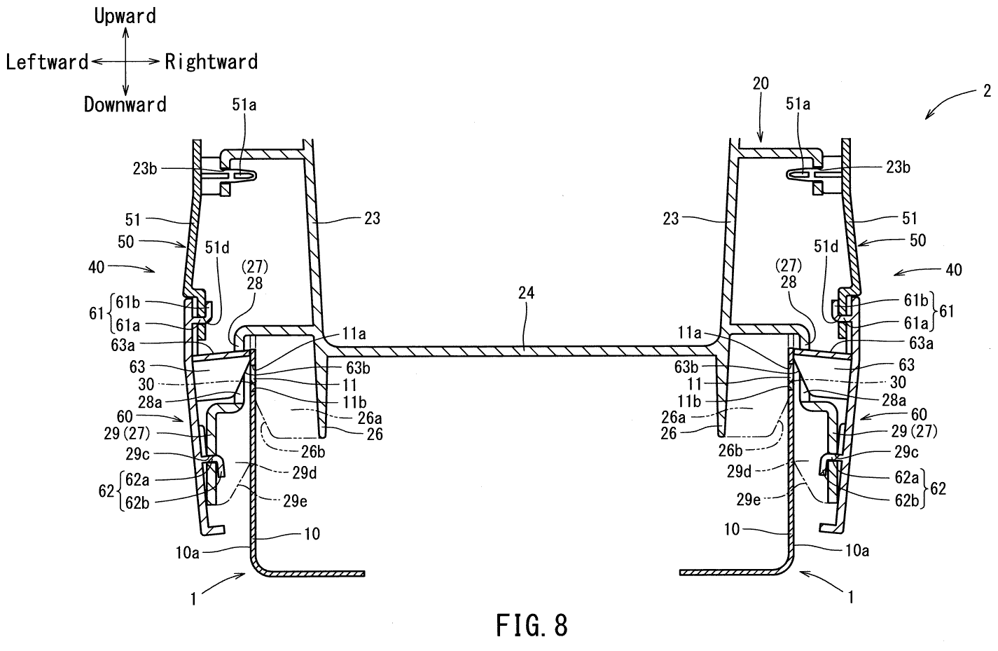

As shown in FIG. 7, the console box 2 is then pressed down until a distal (upper) end of each of the attachment portions 10 contact the oblique end surfaces 63b of the engagement strips 63 formed on each of the right and left lower side panel elements 60. Thereafter, the console box 2 is further pressed down. As a result, as shown in FIG. 8, each of the attachment portions 10 is introduced into the vertical clearance 30 while pressing the engagement strips 63 laterally outward due to contact of the distal end thereof with the oblique end surfaces 63b of the engagement strips 63. That is, each of the attachment portions 10 is introduced into the vertical clearance 30 while arcuately deforming each of the right and the left side panels 40 laterally outward via the engagement strips 63. When the console box 2 is further pressed down, the distal end of each of the attachment portions 10 eventually clear the engagement strips 63.

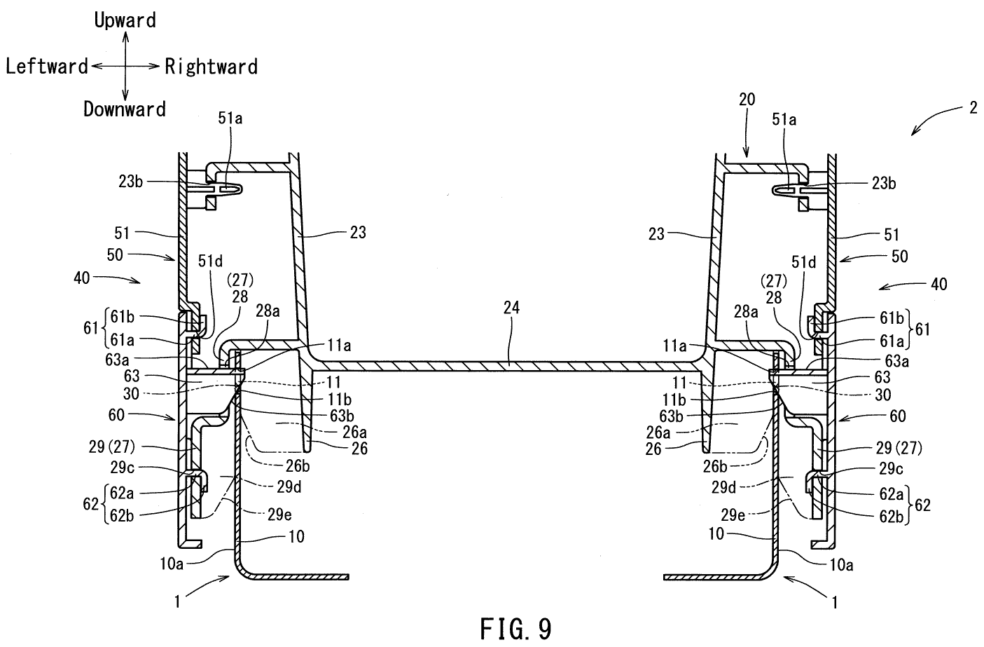

When the console box 2 is successively pressed down after the distal end of each of the attachment portions 10 clears the engagement strips 63, distal ends of the engagement strips 63 enter the engagement holes 11 formed in each of the attachment portions 10. As a result, the right and the left side panels 40 are restored laterally inward. Further, in a condition in which the distal ends of the engagement strips 63 enter the engagement holes 11 of the attachment portions 10, the upper surfaces 63a of the engagement strips 63 contact upper surfaces 11a of the engagement holes 11 while the oblique end surfaces 63b of the engagement strips 63 contact lower surfaces 11b of the engagement holes 11 (FIG. 9). That is, the engagement strips 63 engage the engagement holes 11 of each of the attachment portions 10. As a result, the console box 2 is securely connected to the attachment portions 10 (FIG. 9) with the first downward projection 26 (the projecting strips 26a) and the second downward projection 27 (the projecting strips 29d) of each of the right and left side walls 23 of the console box main body 20 clamping each of the attachment portions 10 therebetween. Thus, the console box 2 is attached to the right and left attachment brackets 1.

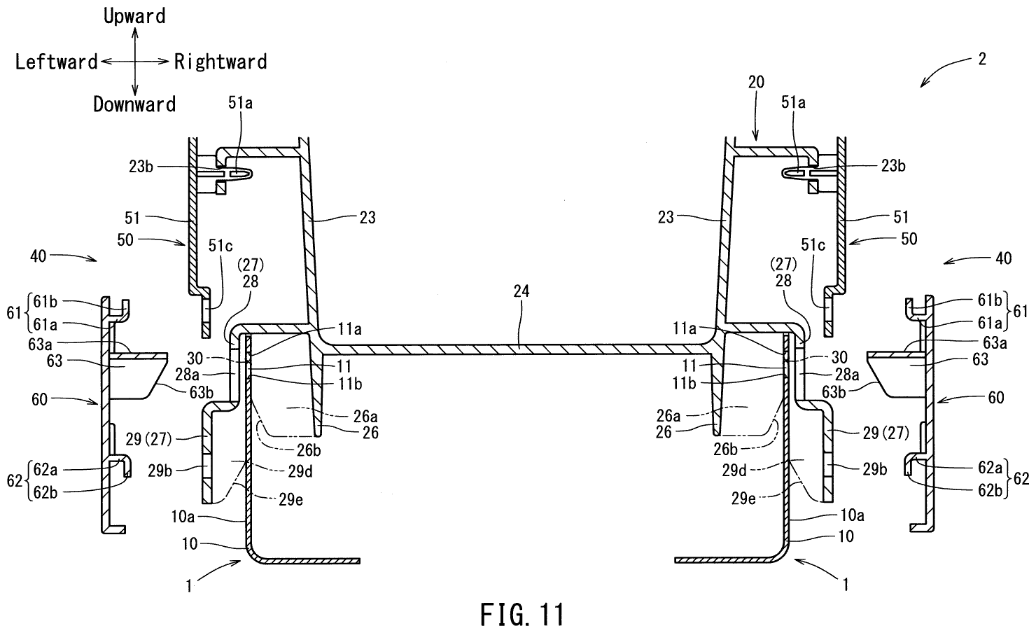

Next, in order to detach the console box 2 from the right and left attachment brackets 1, in a condition in which the console box 2 is attached to the right and left attachment brackets 1 (FIG. 9), the engagement strips 63 are disengaged from the engagement holes 11 of each of the attachment portions 10 by separating the right and left lower side panel elements 60 from the right and left upper side panel elements 50 (FIG. 11). Thereafter, the console box 2 (with the right and left lower side panel elements 60 removed) is simply lifted up from the right and left attachment brackets 1.

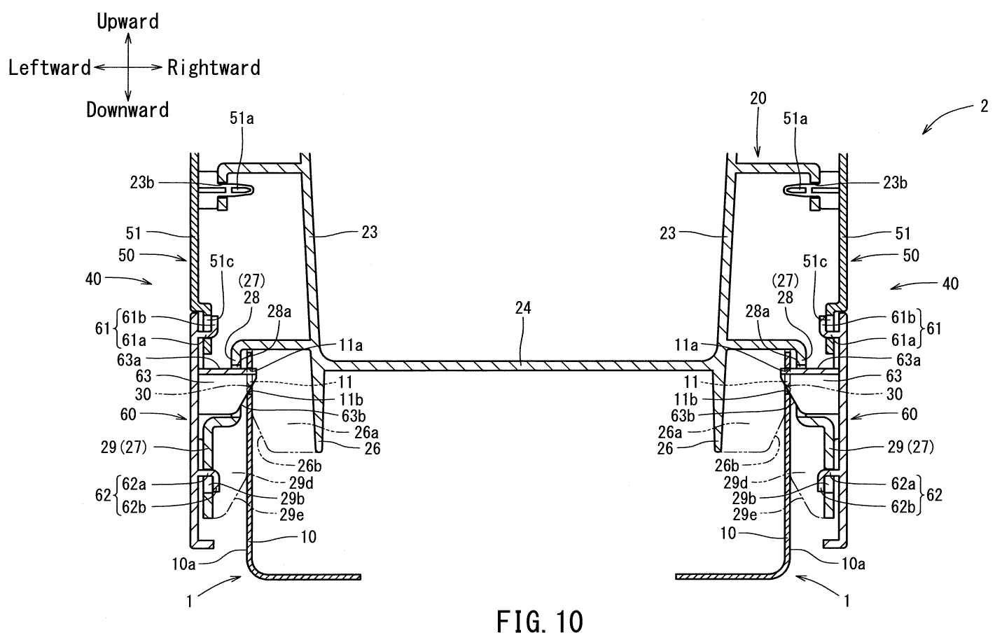

In particular, each of the right and left lower side panel elements 60 is slid forward relative to each of the right and left upper side panel elements 50. As shown in FIG. 10, upon forward sliding of each of the right and left lower side panel elements 60, the base portions 61a of the upper engagement claws 61 move from the rear narrow portions 51d of the engagement holes 51b to the front wide portions 51c of the engagement holes 51b. At the same time, the base portions 62a of the lower engagement claws 62 move from the rear narrow portions 29c of the engagement holes 29a to the front wide portions 29b of the engagement holes 29a. In addition, the engagement claws 64 formed on each of the right and left lower side panel elements 60 are withdrawn from the engagement holes 52a formed on the panel extension 52 of each of the right and left upper side panel elements 50. Further, during forward sliding of each of the right and left lower side panel elements 60, the engagement strips 63 move forward along the insertion holes 28a while sliding the distal ends thereof forward along the engagement holes 11 of the attachment portions 10.

As shown in FIG. 10, in a condition in which each of the right and left lower side panel elements 60 is slid forward relative to each of the right and left upper side panel elements 50, the upper engagement claws 61 (the hook portions 61b) are allowed to be laterally withdrawn from the engagement holes 51b through the front wide portions 51c. Similarly, the lower engagement claws 62 (the hook portions 62b) are allowed to be laterally withdrawn from the engagement holes 29a through the front wide portions 29b. That is, each of the right and left lower side panel elements 60 is allowed to be removed from each of the right and left upper side panel elements 50. In this condition, each of the right and left lower side panel elements 60 is pulled laterally outward so as to be removed from each of the right and left upper side panel elements 50.

As shown in FIG. 11, upon removal of each of the right and left lower side panel elements 60, the engagement strips 63 are disengaged from the engagement holes 11 of each of the attachment portions 10. That is, the console box 2 is allowed to be removed from the attachment portions 10. In this condition, the console box 2 is lifted up from the right and left attachment brackets 1 so as to be removed from the attachment portions 10. Thus, the console box 2 is detached from the right and left attachment brackets 1.

According to this embodiment, the console box 2 can be attached to the right and left attachment brackets 1 having the attachment portions 10 oriented perpendicular to the vehicle panel. Further, the console box 2 can be easily and reliably attached to the right and left attachment brackets 1 by pressing the console box 2 down toward the attachment brackets 1 (the attachment portions 10).

According to this embodiment, when the console box 2 is attached to the right and left attachment brackets 1, the engagement strips 63 of each of the right and left lower side panel elements 60 engage the engagement holes 11 of the attachment portions 10. Therefore, the console box 2 is reliably prevented from being upwardly removed from the right and left attachment brackets 1. Further, when the console box 2 is pressed down toward the attachment brackets 1, each of the attachment portions 10 are introduced into the vertical clearance 30 formed in each of the right and left side walls 23 of the console box main body 20 while the distal end of each of the attachment portions 10 continuously contacts the oblique end surfaces 63b of the engagement strips 63. Therefore, each of the attachment portions 10 can be smoothly received into the vertical clearance 30 until the distal end thereof clears the engagement strips 63, i.e., until the engagement strips 63 engage the engagement holes 11 of each of the attachment portions 10.

According to this embodiment, the right and left lower side panel elements 60 are removed from the right and left upper side panel elements 50 by simply sliding the right and left lower side panel elements 60 relative to the right and left upper side panel elements 50. In addition, when the right and left lower side panel elements 60 are removed from the right and left upper side panel elements 50, the engagement strips 63 are disengaged from the engagement holes 11 of each of the attachment portions 10. Therefore, the console box 2 is easily detached from the right and left attachment brackets 1.

According to this embodiment, the console box 2 is detached from the right and left attachment brackets 1 by simply removing the right and left lower side panel elements 60 from the right and left upper side panel elements 50. In other words, the console box 2 is detached from the right and left attachment brackets 1 without removing both of the right and left upper side panel elements 50 and the right and left lower side panel elements 60 (the right and the left side panels 40) from the console box main body 20.

Naturally, various changes and modifications may be made to the embodiments described herein. For example, the number of the engagement strips 51a, the upper engagement claws 61, the lower engagement claws 62, the engagement strips 63 and the engagement claws 64 may be changed as necessary.

Further, in the embodiment, the console box 2 is shown as an example of the vehicle interior part. However, the vehicle interior part may be a glove box. In addition, in this embodiment, the attachment brackets 1 are shown as an example of the vehicle component. However, the vehicle component is not limited to the attachment brackets 1.

Further, in the embodiment, the console box 2 is completely assembled by coupling the right and left side panels 40 to the console box main body 20 and is then attached to the attachment brackets 1. However, the console box 2 may be partly assembled by coupling only the right and left upper side panels 50 to the console box main body 20 and then be attached to the attachment brackets 1. Thereafter, the right and left lower side panel elements 60 may be coupled to the right and left upper side panels 50, thereby forming the left side panel 40.

Further, the embodiment may be modified as necessary (a first modified embodiment and a second modified embodiment). For example, in the embodiment, the upper side panel element 50 and the lower side panel element 60 of each of the right and left side panels 40 are formed separately from each other. However, in the first modified embodiment, the upper side panel element 50 and the lower side panel element 60 of each of the right and left side panels 40 are integrally formed as a unit. Further, in the first modified embodiment, the engagement strips 51a are replaced with engagement claws similar to the upper engagement claws 61 while the engagement holes 23b are replaced with engagement holes similar to the engagement holes 51b. According to the first modified embodiment, the right and left side panels 40 are coupled to the right and left side wall 23 of the console box main body 20 so as to be removed by sliding them in the front-back direction.

To the contrary, in the second modified embodiment, similar to the first modified embodiment, the upper side panel element 50 and the lower side panel element 60 of each of the right and left side panels 40 are integrally formed. However, unlike the first modified embodiment, in the second modified embodiment, the lower engagement claws 62 are replaced with engagement strips similar to the engagement strips 51a while the engagement holes 29a are replaced with engagement holes similar to the engagement holes 23b. According to the second modified embodiment, the right and left side panels 40 are coupled to the left side wall 23 of the console box main body 20 so as to be removed by pulling them in a lateral direction.

A representative example of the present teaching has been described in detail with reference to the attached drawings. This detailed description is merely intended to teach a person of skill in the art further details for practicing preferred aspects of the present teaching and is not intended to limit the scope of the teaching. Only the claims define the scope of the claimed teaching. Therefore, combinations of features and steps disclosed in the foregoing detailed description may not be necessary to practice the teaching in the broadest sense, and are instead taught merely to particularly describe detailed representative examples of the teaching. Moreover, the various features taught in this specification may be combined in ways that are not specifically enumerated in order to obtain additional useful embodiments of the present teaching.

What is claimed is:

1. An attaching structure for attaching a vehicle interior part to a vehicle component of a vehicle body, the vehicle interior part including a main body and a pair of side panels, the attaching structure comprising:
a pair of attachment portions of the vehicle component configured to be oriented perpendicular to the vehicle body, wherein the attachment portions include a plurality of engagement holes formed therein;
a pair of clamping members of the main body of the vehicle interior part; and
an engagement strip on an inner surface of each side panel of the vehicle interior part;
wherein the clamping members of the main body of the vehicle interior part clamp the attachment portions of the vehicle component to couple the main body of the vehicle interior part to the vehicle component;
wherein the engagement strips on the inner surfaces of the side panels of the vehicle interior part engage the engagement holes of the attachment portions of the vehicle component to couple the side panels of the vehicle interior part to a pair of side walls of the main body the vehicle interior part.

2. The vehicle interior part attaching structure of claim 1, wherein the engagement strips include upper surfaces and oblique end surfaces inclined with respect to the upper surfaces, and wherein the upper surfaces and the oblique end surfaces contact the engagement holes.

3. The vehicle interior part attaching structure of claim 1, wherein the side panels are removably coupled to the side walls of the interior part main body.

4. The vehicle interior part attaching structure of claim 1, wherein each side panel of the vehicle interior part includes a first side panel element and a second side panel element,
wherein the engagement strips of inner surfaces of the side panels of the vehicle interior part are formed on the second side panel element, and
wherein the second side panel element is removably coupled to the first side panel element and configured to be removed from the first side panel element by sliding.

5. The vehicle interior part attaching structure of claim 4, wherein each engagement hole of the attachment portions of the vehicle component has an elongated rectangular shape such that the engagement strips move along the engagement holes.

6. A vehicle interior part configured to be attached to a vehicle component, wherein the vehicle component includes a pair of attachment portions each of which has engagement holes formed therein, the vehicle interior part comprising:
a main body having side walls; and
a pair of side panels having inner surfaces;
wherein the vehicle interior part main body includes a pair of clamping members having insertion holes;
wherein each of the side panels includes engagement strips formed on each of the inner surfaces;
wherein the main body is configured to be coupled to the attachment portions of the vehicle component with the clamping members clamping the attachment portions;
wherein the side panels are configured to be coupled to the side walls of the main body, and
wherein the engagement strips of the side panels are configured to engage the engagement holes of the attachment portions of the vehicle component through the insertion holes of the clamping members when the side panels are connected to the side walls of the vehicle interior part main body connected to the attachment portions.

7. The vehicle interior part of claim 6, wherein the clamping members include clearances formed therein, and
wherein each clearance is configured to receive one of the attachment portions of the vehicle component.

8. The vehicle interior part of claim 6, wherein each side panel includes a first side panel element and a second side panel element;
wherein the engagement strips are formed on the second side panel element; and
wherein the second side panel element is removably coupled to the first side panel element.
